(19) United States
(12) Patent Application Publication
(10) Pub. No.: US 2013/0103608 A1
(43) Pub. Date: Apr. 25, 2013

(54) Location Determination and Map Building

(71) Applicants: Germán Carlos Scipioni, San Antonio, CA (US); Ares Sakamoto, Cedar Park, TX (US); West Stringfellow, Los Gatos, CA (US); Joel Yarbrough, Oakland, CA (US)

(72) Inventors: Germán Carlos Scipioni, San Antonio, CA (US); Ares Sakamoto, Cedar Park, TX (US); West Stringfellow, Los Gatos, CA (US); Joel Yarbrough, Oakland, CA (US)

(73) Assignee: eBay Inc., San Jose, CA (US)

(21) Appl. No.: 13/278,242

(22) Filed: Oct. 21, 2011

(51) Int. Cl. G06Q 30/00

(52) U.S. Cl. 705/346

(57) ABSTRACT

The present disclosure involves a method comprising: determining a location of a user inside a facility; accessing an information map of the facility based on at least one of: electronic scans of items in the facility made by the user and a planogram; and offering a service based on the information map and the location of the user. The present disclosure also involves an electronic device comprising: an interface for receiving an input from a user and communicating an output to the user; a transceiver for electronically communicating with external devices; a computer processor for executing instructions; and a memory storage for storing the instructions, the memory storage further comprising a program module for: constructing a map of a facility in response to purchases made by the user; and offering a service in response to a location of the user and a shopping history of the user.

### BACKGROUND

1. Technical Field

The present disclosure generally relates to performing shopping-related transactions, and more particularly, to gathering information and offering services based on the shopping-related transactions.

2. Related Art

Recent advances in the fields of telecommunications and integrated circuits have drastically increased the popularity of portable electronic telecommunication devices. As some non-limiting example, these portable telecommunication devices may include smart phones, computer tablets, or laptops. Users of these devices may use them to perform a variety of tasks. For example, many smart phones and computer tablets can be used to scan a product at a store and extract information about such product. The extracted information may include the description of the product, names of other retailers (either online or physical) carrying the product, prices of the product at the other retailers, and other suitable information. These capabilities of the portable telecommunication devices have not, however, been fully utilized to create a better shopping experience for their users who may be shopping at stores, nor have these capabilities been utilized to improve the store's efficiency.

Therefore, while existing mobile telecommunication devices have been generally adequate at performing their intended tasks, their fully capabilities have not been utilized in certain aspects. It would be advantageous for a service provider to take advantage of the capabilities of the mobile telecommunication devices to create a more pleasant shopping experience for the users of the telecommunication devices and to optimize a retailer's efficiency.

### SUMMARY

One of the broader forms of the present disclosure involves a method. The method involves: determining a location of a user inside a facility; accessing, by a processor of a service provider, an information map of the facility based on at least one of: electronic scans of items in the facility made by the user and a planogram of the facility; and offering a service based on the information map and the location of the user.

Another one of the broader forms of the present disclosure involves an electronic device. The electronic device involves: an input/output interface operable to receive an input from a user and communicate an output to the user; a transceiver operable to electronically communicate with external devices; a computer processor operable to execute instructions; and a memory storage operable to store the instructions, the memory storage further comprising a program module that is operable to: construct a map of a shopping facility in response to purchases made by the user at the shopping facility; and offer a service to the user in response to a location of the user and a shopping history of the user.

Another one of the broader forms of the present disclosure involves an apparatus comprising a non-transitory, tangible computer readable storage medium storing a computer program. The computer program has instructions that when executed, perform: detecting an electronic scan of a product in a facility; extracting a property of the product in response to the detecting; constructing, using at least in part the extracted property of the product, an information map of the facility; and offering a service based on the information map of the facility.

### BRIEF DESCRIPTION OF THE DRAWINGS

FIGS. 1-3 illustrate example user interfaces of an example application program according to various aspects of the present disclosure.

FIG. 4 illustrates an example block diagram of an electronic device on which the application program of FIGS. 1-3 may be implemented according to various aspects of the present disclosure.

FIG. 5 illustrates a flowchart containing process flows according to various aspects of the present disclosure.

FIG. 6 illustrates a block diagram of a computer system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

Rapid advances in the fields of telecommunications and integrated circuits have led to the popularization of portable electronic devices. In addition to telecommunication and computing capabilities, these portable electronic devices are often equipped with cameras, Global Positioning System (GPS) transceivers, and various kinds of sensors such as accelerometers, proximity sensors, ambient light sensors, compasses, gyroscopes, etc. These features, along with the communication and computing capabilities, make the modern day portable electronic devices very versatile and powerful. Unfortunately, the potential of these devices have not been fully realized in a retail context. For example, the various capabilities of the portable electronic devices have not been utilized to provide a more pleasant shopping experience for users of these electronic devices, nor have these capabilities been sufficiently explored to optimize a retailer's efficiency.

According to the various aspects of the present disclosure, a method and apparatus are discussed below that take advantage of the various capabilities of the portable electronic devices to offer benefits to both a user and a retailer.

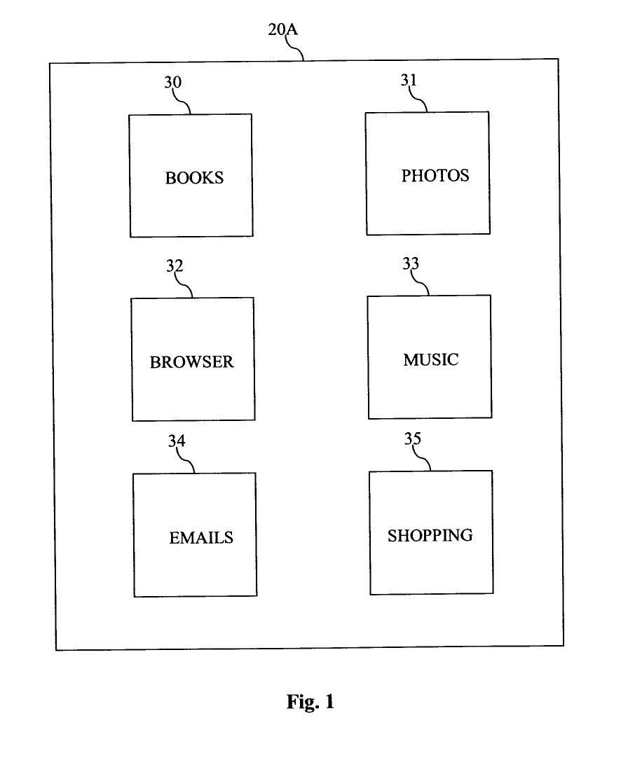

FIG. 1 illustrates an example user interface 20A for a portable electronic device. In the illustrated embodiment, the portable electronic device is a smart phone. In alternative embodiments, the portable electronic device may be another suitable electronic device such as a computer tablet or a laptop. A user may download Application Software programs, also known as “apps,” to the portable electronic device. In general, apps are computer software programs designed to execute specific tasks. As examples, both Apple's ® App Store and Google's Android Market offer a plethora of apps, including entertainment programs, business applications, file management tools, and other widgets, etc.

In the interface 20A illustrated in FIG. 1, example apps 30-35 are shown, corresponding to “BOOKS,” “PHOTOS,” “BROWSER,” “MUSIC,” “EMAILS,” and “SHOPPING.” Other apps may exist on the portable electronic device, but they are not shown or discussed herein for the sake of simplicity. As indicated by the name, the apps 30-35 allow the user to read books, view photos, browse the web, listen to music, check emails, and perform shopping related activities, respectively. Each of these apps 30-35 may be designed and implemented by a service provider, where the service provider may be a computer software and/or hardware company. The following discussions will focus on the app 35, which is designed to enhance the user's shopping experience.

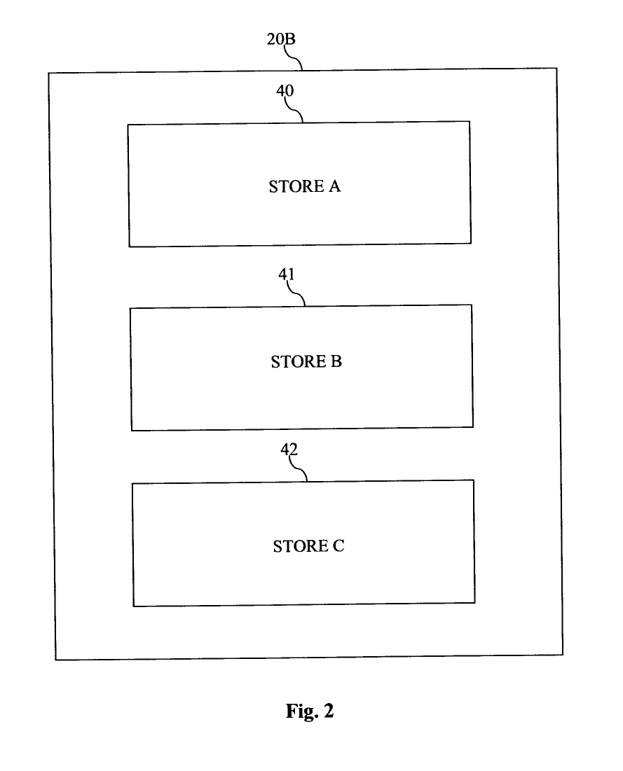

When the user activates the “SHOPPING” app 35 (for example by touching it or clicking on the icon in the interface 20), another user interface 20B may be displayed to the user, as illustrated in FIG. 2. The user interface 20B contains icons 40-42 labeled “STORE A,” STORE B,” and “STORE C,” respectively. The icons 40-42 may also be considered apps or sub-apps within the app 35 of FIG. 1. Each of the icons 40-42 corresponds to a shopping facility, which may be a retail store in the illustrated embodiment. In other embodiments, the shopping facilities may include restaurants, amusement parks, car dealerships, malls, airports, train/bus stations, and office buildings, etc.

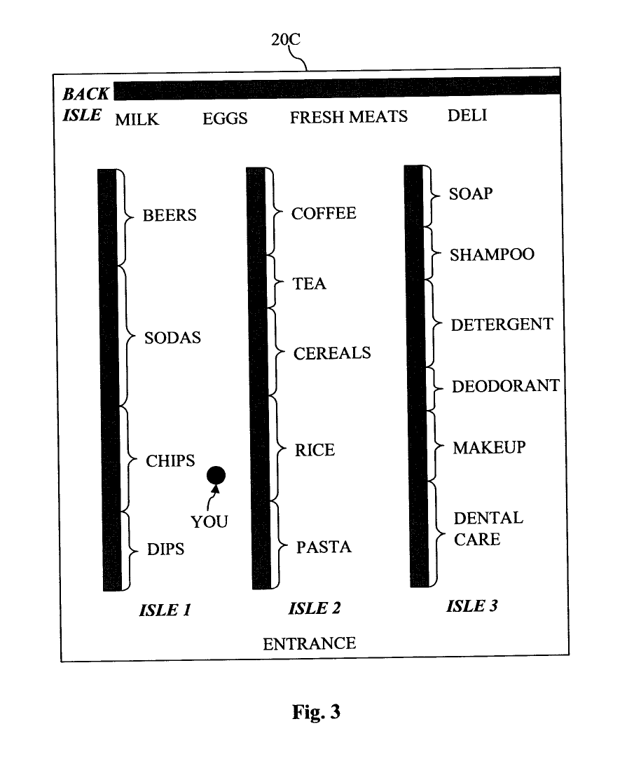

Suppose the user is interested in going shopping at store A. He may manually activate the icon 40 corresponding to store A, which will bring up another user interface 20C, shown in FIG. 3. Alternatively, the user interface 20C may be automatically invoked, as the app 35 may be “smart” enough to detect the store the user is at, for example by GPS signals, or technologies inside the store such as its Wi-Fi network or Radio Frequency Identification (RFID) devices installed at the store, or by one or more pictures of the store, or by a Quick Response (QR) code (e.g., a two dimensional black and white bar code) as the user “checks in” to the store.

The user interface 20C displays a map of the store A. The map contains information regarding the layout of the store, the position (or location) of items in the store, as well as the position of the user inside the store. In some embodiments, the map may only illustrate a portion of the store A, especially if the screen size of the portable electronic device is relatively small. The user may scroll on the screen to view other portions of the store A. In other embodiments, the store A may be shown in its entirety. The user may also zoom in and out of a particular region of the store to view things in more detail. Similarly, the user may activate the icon 41 to view a map of store B or activate the icon 42 to view a map of store C.

Returning to the embodiment illustrated in FIG. 3, the store A may be a grocery store. Aisles 1-3 and a back aisle of the grocery store are displayed in the user interface 20C. In more detail, aisle 1 includes items such as beers, sodas, chips, and dips. Aisle 2 includes items such as coffee, tea, cereals, rice, and pasta. Aisle 3 includes items such as soap, shampoo, detergent, deodorant, makeup, and dental care products. The back aisle includes items such as milk, eggs, fresh meats, and deli. Additional aisles and the items on those aisles are not displayed herein.

The user's position inside the store A is shown in the interface 20C. The user's location may be determined using several methods. In certain embodiments, electronic beacons may be placed at various locations inside the store. These beacons may be RFID devices in some embodiments. Each beacon may be associated with an aisle or an item type such as beers or coffee. The locational information of the beacons is also sent to the service provider offering the app 35 of FIG. 1. When the user walks around in the store, as he approaches a particular item, the beacon associated with that item senses the user's presence by way of electronic communication with the user's portable electronic device. As such, the user's location inside the store can be determined using the beacons. It is understood that multiple beacons may also be deployed for each aisle or for each product type. Accordingly, the location of the user may be determined with greater precision.

Furthermore, instead of, or in addition to, placing RFID devices throughout the store, electronic communication devices may be placed in several key geographical points of the store. These devices may individually or simultaneously communicate with the user's portable electronic device. The user's movement inside the store will alter these communication signals between the user and the electronic communication devices, for example timing of the signals may be altered due to signal propagation delay. Such information can be used to triangulate and calculate the user's position inside the store as well. Based on the discussions above, it can be seen that a user's location inside a facility may be ascertained with or without the benefit of GPS signals, which may be unavailable indoors or not provide the necessary accuracy.

Though RFID devices have been used to illustrate “beacons” herein, it is understood that beacons are not limited to RFID devices and may in fact include other suitable devices such as cameras or other types of electronic communication devices in alternative embodiments. For example, in some embodiments, beacons may include micro-GPS electronic communication devices, for example micro-GPS transceivers or transmitters.

These micro-GPS electronic communication devices may be positioned at various predetermined locations inside the store. The user's mobile electronic communication device may include a GPS transceiver that is operable to communicate with the micro-GPS electronic communication devices inside the store. Based on the electronic communication exchange, the location of the user may be determined.

The map of the store A containing the locational information of its various items may also be obtained in several ways. For example, in case store A belongs to a retail chain, the headquarters may release a planogram to each of its regional stores. A planogram is a diagram or a schematic that illustrates the manner and location each product should be displayed. For example, the planogram may dictate that beers should be displayed on shelves in aisle 1 towards the back, dips should be displayed on shelves in aisle 1 towards the front, milk and eggs should be displayed on shelves in the back aisle, etc. In other words, a planogram offers a simplified blueprint of a store layout. The store A may send the planogram to the service provider offering the app 35 (FIG. 1), so that the service provider may display a map of store A to the user when requested.

However, the planogram may be altered or tweaked by managers (or another person in charge) of a regional store. Thus, to construct a more precise and accurate map, other techniques may be used. In some embodiments, the user may use the portable electronic device to electronically scan the items, for example by taking a picture of either the item itself or its bar code. The electronic scan of the item is communicated to the service provider, which may utilize a computer server to store such information. Also as discussed above, the user's location may be determined by beacons or other suitable methods such as triangulation using electronic communication signals. Since the user's location is known, and an electronic scan of the item by the user is detected, then it follows that the scanned item is near the user's present location. This information may be gathered and stored by the service provider.

As an example, it has been determined that the user is presently located at aisle 1, ten feet away from the end of the aisle facing the entrance of the store. The user uses his portable electronic device to scan a bag of potato chips. This scan is electronically communicated to the server of the service provider. The service provider then assigns the user's location to the bag of potato chips, which is at aisle 1 and ten feet away from the end of the aisle facing the entrance. As the user scans other items, the locations of the other items can also be gathered and stored in a database of the service provider. In a similar manner, other users of the app 35 may help the service provider gather locational information of items inside a store by scanning items as they shop. Over time, the service provider can build an extensive and accurate database containing locational information of all items in a particular store. Even in situations where a planogram is not available, the service provider can still use the database to construct a locational map of a store and offer that map to the user.

In some embodiments, the user's electronic scan of the items not only helps collect locational information for the items, but also other information such as pricing information of the items. Thus, the service provider receiving such information may be able to construct an information map of a store, where the information map contains not just the layout of the store and location of the items inside the store, but also the pricing information, date information, or other suitable information of the items inside the store. It is understood that the users discussed herein may also include employees or other personnel associated with a store. For example, as employees scan items (e.g., doing a price check), such information may be communicated to the database of the service provider as well. In addition, in some embodiments, the scans made by the employees (or by the users) may be first sent electronically to a database of the store, and thereafter the service provider may retrieve such information from the store.

The information map constructed may be a generic map common to all users, or may be a personalized map tailored to each user based on the user's preferences and shopping history. For example, if a user buys milk and cereal with greater frequency than other items, then the personalized map displayed to that user may highlight the locations of milk and cereal. As another example, the user may be allowed to input a wish list of items he needs to purchase, such as eggs and pasta. Taking into account the user's present location, the information map may display the fastest or most efficient route that user may take to make those purchases. The route may be given in the form of textual directions or in the form of a map. The information map may also display the pricing information of those items as well as whether these items are on sale, or how fresh they are (e.g., based on expiration dates).

The information map also lets the user know his exact position inside a store. For example, if the user is lost inside a store, he can scan a random item such as a bottle of shampoo, and the information map will let him know which aisle he is at, and how he can navigate to other areas of the store.

The information map may be updated in real time based on the electronic scans of items made by users. Thus, it is a constantly-changing dynamically-evolving map. Information on items inside a facility may be gathered based on technology (such as RFID devices) inside the facility to create this map. Once the map is created, services may be offered. In some embodiments, the services may be offered to the users as discussed above. For example, the services may include helping the user determine his own location inside a store and/or helping the user navigate through the store to find items he wishes to purchase.

As another example of a service offered to a user, in an amusement park, beacons may be placed at intervals along a queue for each ride. The size of the queue (number of people waiting in line for the ride) can thus be calculated. A user may inform the app which rides he is interested in. When the queuing time for that ride is reduced, the user may receive a notification to that effect and directions on how to get to the ride.

As yet another example of services offered to the user, promotions or coupons may be selectively displayed to the user based on the user's shopping history and/or location. For instance, a user may have repeatedly bought coffee, among other items, during his previous visits to a store. This information is collected and analyzed by the service provider. During a visit to the store, as the user walks by the coffee aisle, his presence is detected, for example by an RFID chip located in the aisle. The app 35 thus “knows” that the user is close to the coffee products, which he may have a high buying interest. Consequently, the app 35 may send an alert to the user, informing him that coffee is nearby. The app 35 may also offer a coupon to the user, depending on agreements made with the store. In this manner, the user may receive personalized advertising that is tailored to his preferences and location.

In addition to offering services to users, the informational map may also be used to offer services to retailers. Like the users, the retailers may download the app 35 (or a different version of the app) to a computerized device. The app 35 may display the locations of a plurality of users (customers) in the retailer's shopping facility, which may be a store, a restaurant, a theme park, etc. The purchasing history for each user may also be made available to the retailer. Thus, the retailer may offer each user a personalized coupon/rebate for the right product, at the right location and the right time, for example by offering the user a coupon for coffee in the example discussed above.

The efficiency of the retailer may also be optimized using the information map. For example, as a fast food enthusiast user walks by a fast food restaurant, he may be offered a coupon for a hamburger. The user can download the coupon, electronically pay for the meal, and walk into the fast food restaurant and pick up his order, which is made as soon as the user finishes payment. The user can wait outside the restaurant and bypass the lines when he goes in the restaurant to pick up his order. The restaurant would become less crowded as more users adopt this approach, and yet the overall sales of the restaurant may remain the same or better.

Another reason for the improvement of the retailer's efficiency is due to freed up resources. Previously, a retailer may need to staff employees inside their stores to help answer customers' questions, for example questions regarding the layout of the store or the location of particular items. Here, using the embodiments of the present disclosure, the customers (users) may be able to find desired items much more easily themselves and thus need not rely on store employees. Thus, these employees may be freed up to do other tasks, thereby improving productivity of store personnel. In addition, using the embodiments disclosed herein, it is easier for a retailer to get a hold of a user who has questions or otherwise needs assistance. For example, by clicking a button, the user can send a signal to the retailer that he needs help. Since the location of the user is now readily available to the retailer, the retailer can send a clerk to help the user more quickly.

The retailer may also enjoy improved sales. The above mentioned shopping app may let the retailer generate a sales “heat map” of their facility. The retailer may be able to track information such as what item(s) each user is buying, the amount of time it takes for a user to get from point A to point B inside the store, the shopping patterns of each user, etc. Based on such information, the retailer may be able to reconfigure the layout of the store to make the purchases of items easier for users. For example, if it has been detected that users tend to buy chips and beers together, then the app may make suggestions to the retailers to place the beers and chips next to each other in the same aisle to make the user's purchases more efficient. In other words, based on the detected user shopping statistics, the service provider of the app may make various recommendations to the facility, such as recommendations with respect to the layout or configuration of the facility.

As the user is able to complete his shopping more quickly than before, his overall shopping experience may be improved, which may make him a repeat customer. Furthermore, a faster shopping trip for one or more users results in reduced crowd traffic at a retailer's shopping facility. This may become increasingly beneficial in busy shopping times, such as the holiday seasons. Therefore, improvements made to the user's shopping efficiency benefits not only the users, but also the retailers.

The information map may also let the retailer collect the real time inventory information inside its facility. At the start of the day, the retailer may have inventory information on one or more items inside the facility. This information may be sent to the service provider of the app 35. As users make purchases on items in the facility, the information map may send updated the inventory information to the retailer constantly. As the inventory for a particular item is running low, the retailer may be notified, and thereafter the retailer may be able to restock that item in time before it runs out. Alternatively, if an item is currently unavailable as the user scans the price tag or the barcode of the item, the retailer may notify the user that its sister store nearby may still carry that item. Or the user can still pay for the item here, and the retailer will arrange to have the item delivered to the user when the item becomes available again.

The information map discussed above may also help resolve transactional disputes. For example, retailers may often receive complaints from customers who claim they were charged for item(s) they did not purchase. The authenticity of such claims may be difficult to verify, and the retailers frequently concede to the claims, which leads to losses in profit. Using the embodiments of the present disclosure, the retailers now may be able to track the user's movement inside their facilities, which can be used to rebut the customer's claims or substantiate the retailer's position.

As an example, suppose the retailer is an all-you-can-eat buffet restaurant. A customer user is detected to have spent one hour in the restaurant at a certain date and time. The user later claims that he was fraudulently charged for a meal that he did not purchase at the restaurant at that date and time. The restaurant may then present the user's detected (and recorded) activities inside the restaurant on that day and time as proof that he in fact has consumed a meal there. As such, transactional disputes between customers and retailers may be handled more efficiently and more accurately.

For these reasons discussed above, it can be seen that an evolving information map can be constructed based on real time feedback from users inside a facility and based on technology available inside the facility. The information map may offer services to users and/or retailers. As a result of the services offered, the user's shopping experience may be improved, and the retailer's efficiency and profit may be enhanced.

It is understood that although the embodiments above describe the service provider offering the app 35 and the retailer as separate entities, they may in fact be the same entity in other embodiments. That is, the retailer itself may offer a downloadable app to users, and that retailer may extract information of the retailer's facility as well as the behavior of the users using the app. In addition, the app need not necessarily be in the form discussed above and shown in FIGS. 1-3. In some embodiments, a store may embed the information map service in another general store app provided to the user. Or alternatively, the app may be integrated with a navigation service/app that is built-in or downloaded to the portable electronic device.

Furthermore, in some embodiments, the users need not necessarily have a “smart” portable electronic device to take advantage of the various benefits of the present disclosure. For example, RFID chips may be installed in shopping carts or baskets of a store. The RFID chips may interact with the beacons inside the facility to let the user ascertain his own location as well as the location of desired items. In some embodiments, the user may be allowed to input a username and a password (for example into a display screen on the shopping cart or at a kiosk inside the store) to get a more personalized shopping experience based on his past shopping behavior.

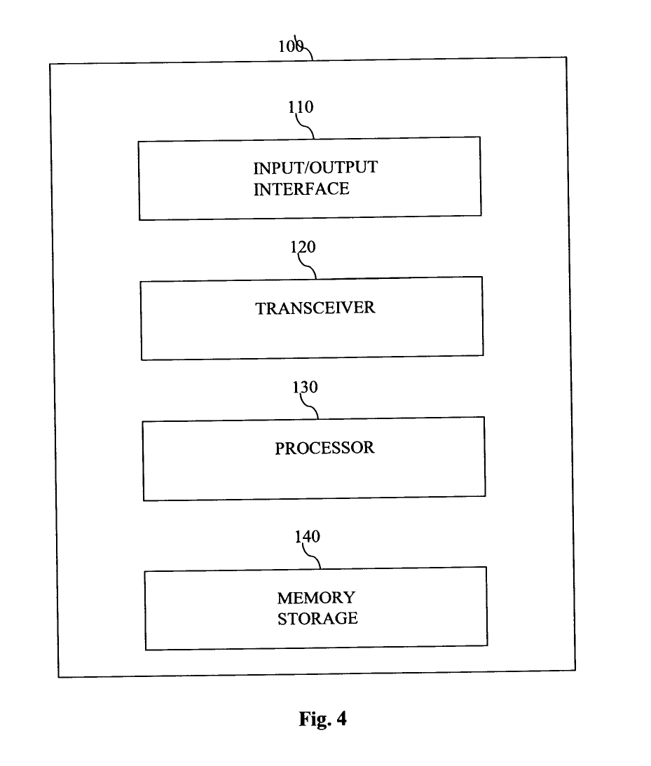

FIG. 4 is a simplified block diagram of an example electronic device 100 on which the app 35 discussed above may be implemented according to various aspects of the present disclosure. The electronic device 100 may be a portable personal electronic device, such as a smart phone or a tablet. The electronic device may also be a computer, for example a server computer. The electronic device 100 includes an input/output interface 110. The interface 110 is operable to receive an input from a user and communicate an output to the user. The user may be a customer of a shopping facility or the shopping facility itself (or a person in charge of the shopping facility). In an embodiment, the input/output interface 110 includes a visual display unit, for example a touch-sensitive screen.

The electronic device 100 includes a transceiver 120. The transceiver 120 is operable to electronically communicate with external devices. In an embodiment, the transceiver 120 is operable to wirelessly communicate with RFID devices. The electronic device 100 also includes a computer processor 130 that is operable to execute computer instructions and a memory storage 140 that is operable to store the computer instructions.

The memory storage 140 also contains a program module that is an embodiment of the app 35. The program module is operable to construct a map of a shopping facility in response to purchases made by the user at the shopping facility. The program module is also operable to offer a service to the user in response to a location of the user and a shopping history of the user. In some embodiments, the program module is operable to determine the location of the user in response to electronic communication between the transceiver 120 and one or more external electronic beacon devices placed at various points inside the shopping facility. In embodiments where the input/output interface 110 contains a visual display unit, the visual display unit is operable to display the map of the shopping facility. In certain embodiments, the program module is also operable to generate navigation instructions in response to the location of the user and merchandise the user wishes to buy, and display the navigation instructions on the visual display unit. In some embodiments, the map of the shopping facility contains locational information, pricing information, and availability information of the merchandise of the shopping facility.

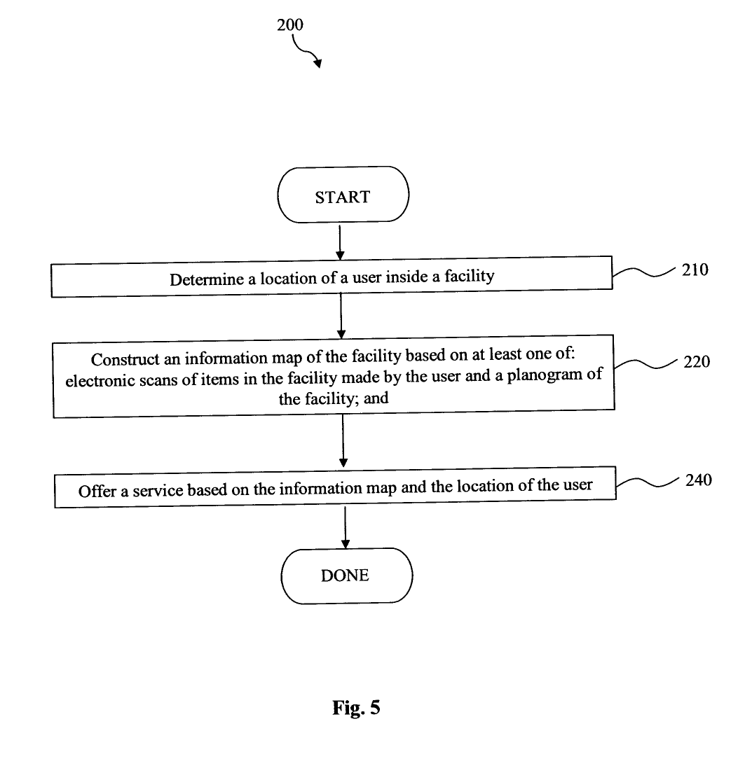

FIG. 5 is a flowchart illustrating a method 200 according to various aspects of the present disclosure. The method 200 includes a block 210 in which a location of a user inside a facility or within a defined space is determined. The facility may be a shopping facility, such as a store. In some embodiments, the block 210 includes detecting electronic communications between beacons installed at various positions in the facility and a portable electronic device of the user. The beacons may include RFID devices.

The method 200 includes a block 220 in which an information map of the facility is accessed based on at least one of: electronic scans of items in the facility made by the user and a planogram of the facility. In some embodiments, the information map is electronically accessed by a computer processor of a service provider. The items may include merchandise of a shopping facility. The information map may contain locational information of each of the scanned items in the facility. The information map may also contain pricing information and availability information of each of the scanned items in the facility. In some embodiments, the information map is a personalized information map for the user based on a shopping history of the user. The execution of the block 220 may also involve constantly updating the information map in response to recent electronic scans of the items.

The method 200 includes a block 230 in which a service is offered based on the information map and the location of the user. In some embodiments, the services are offered to the user. For example, the services offered to the user may include: suggesting an item to the user based on the location of the user; offering a promotion to the user based on a shopping history of the user; and giving directional instructions to the user based on the location of the user and an item the user wishes to purchase. In other embodiments, the services may be offered to the facility. For example, the services offered to the facility may include: gathering user shopping statistics; making recommendations with respect to layout and configuration of the facility in response to the gathering the user shopping statistics; and updating inventory information in real time. The gathering user shopping statistics may include: tracking purchases made by each one of a plurality of users shopping at the facility; tracking locational movements of each of the plurality of users; and tracking delays experienced by each of the plurality of users.

It is understood that the method 200 may include additional steps that may be performed before, during, or after the blocks 210-230. For the sake of simplicity, these additional steps are not discussed in detail herein.

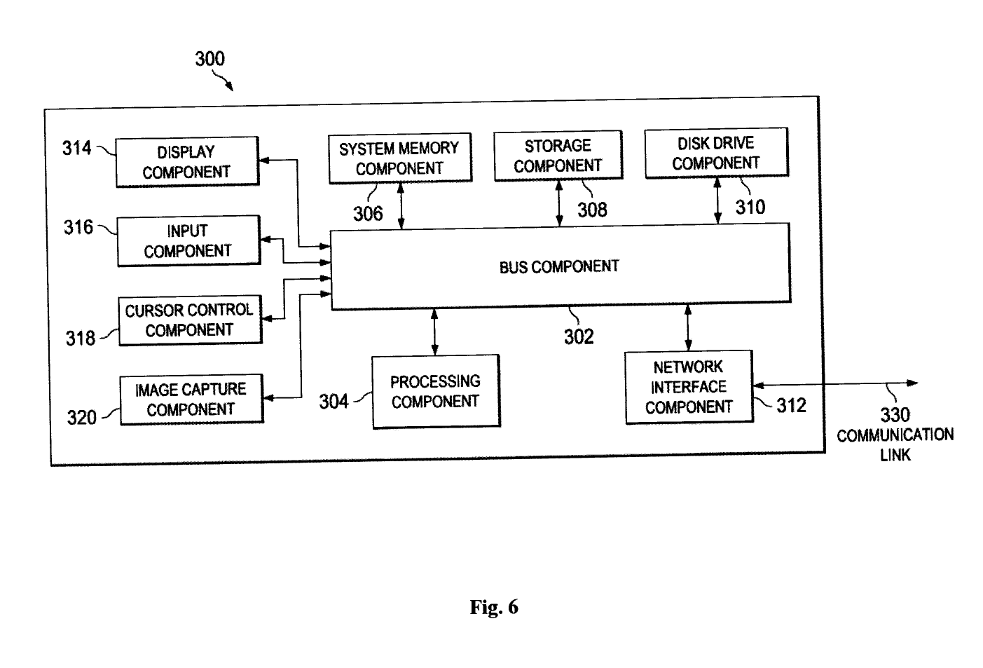

FIG. 6 is a block diagram of a computer system 300 suitable for implementing various methods and devices described herein, for example, the various method blocks of the method 200. In various implementations, the portable electronic devices may comprise a network communications device (e.g., mobile cellular phone, laptop, personal computer, tablet, etc.) capable of communicating with a network. The devices used by the service providers to execute the apps may a network computing device (e.g., a network server, a computer processor, an electronic communications interface, etc.). Accordingly, it should be appreciated that each of the devices may be implemented as the computer system 300 for communication with a network in a manner as follows.

In accordance with various embodiments of the present disclosure, the computer system 300, such as a mobile communications device and/or a network server, includes a bus component 302 or other communication mechanisms for communicating information, which interconnects subsystems and components, such as processing component 304 (e.g., processor, micro-controller, digital signal processor (DSP), etc.), system memory component 306 (e.g., RAM), static storage component 308 (e.g., ROM), disk drive component 310 (e.g., magnetic or optical), network interface component 312 (e.g., modem or Ethernet card), display component 314 (e.g., touch-screens, cathode ray tube (CRT) displays, or liquid crystal display (LCD)), input component 316 (e.g., keyboard or touch-sensitive components operable to detect a touch by a human body), cursor control component 318 (e.g., mouse or trackball), and image capture component 320 (e.g., analog or digital camera). In one implementation, disk drive component 310 may comprise a database having one or more disk drive components.

In accordance with embodiments of the present disclosure, computer system 300 performs specific operations by processor 304 executing one or more sequences of one or more instructions contained in system memory component 306. Such instructions may be read into system memory component 306 from another computer readable medium, such as static storage component 308 or disk drive component 310. In other embodiments, hardwired circuitry may be used in place of (or in combination with) software instructions to implement the present disclosure.

Logic may be encoded in a computer readable medium, which may refer to any medium that participates in providing instructions to processor 304 for execution. Such a medium may take many forms, including but not limited to, non-volatile media and volatile media. In one embodiment, the computer readable medium is non-transitory. In various implementations, non-volatile media includes optical or magnetic disks, such as disk drive component 310, and volatile media includes dynamic memory, such as system memory component 306. In one aspect, data and information related to execution instructions may be transmitted to computer system 300 via a transmission media, such as in the form of acoustic or light waves, including those generated during radio wave and infrared data communications. In various implementations, transmission media may include coaxial cables, copper wire, and fiber optics, including wires that comprise bus 302.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 330 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 300 may transmit and receive messages, data, information and instructions, including one or more programs (i.e., application code) through communication link 330 and communication interface 312. Received program code may be executed by processor 304 as received and/or stored in disk drive component 310 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
determining a location of a user inside a facility;
accessing, by a processor of a service provider, an information map of the facility, wherein the information map is based on at least one of: electronic scans of items in the facility made by the user and a planogram of the facility; and
offering a service based on the information map and the location of the user.

2. The method of claim 1, wherein the determining the location comprises detecting electronic communications between beacons installed at various positions in the facility and a portable electronic device of the user.

3. The method of claim 2, wherein the beacons comprise Radio Frequency Identification (RFID) devices.

4. The method of claim 1, wherein the information map comprises locational information of each of the scanned items in the facility.

5. The method of claim 4, wherein the information map further comprises pricing information and availability information of each of the scanned items in the facility.

6. The method of claim 1, wherein the information map comprises a personalized information map for the user based on a shopping history of the user.

7. The method of claim 1, wherein the information map is constantly updated in response to recent electronic scans of the items.

8. The method of claim 1, wherein the offering the service comprises offering the service to the user.

9. The method of claim 7, wherein the offering the service to the user comprises at least one of:
suggesting an item to the user based on the location of the user;
offering a promotion to the user based on a shopping history of the user;
giving directional instructions to the user based on the location of the user and an item the user wishes to purchase; and
sending staff to the location of the user.

10. The method of claim 1, wherein the offering the service comprises offering the service to the facility.

11. The method of claim 10, wherein the offering the service comprises at least one of:
gathering user shopping statistics;
making recommendations with respect to layout and configuration of the facility in response to the gathering the user shopping statistics; and
updating inventory information in real time.

12. The method of claim 11, wherein the gathering the user shopping statistics comprises:
tracking purchases made by each one of a plurality of users shopping at the facility;
tracking locational movements of each of the plurality of users; and
tracking delays experienced by each of the plurality of users.

13. The method of claim 1, wherein the facility comprises a shopping facility, and wherein the items comprise merchandise of the shopping facility.

14. An electronic device, comprising:
an input/output interface operable to receive an input from a user and communicate an output to the user;
a transceiver operable to electronically communicate with external devices;
a computer processor operable to execute instructions; and
a memory storage operable to store the instructions, the memory storage further comprising a program module that is operable to:
construct a map of a shopping facility in response to purchases made by the user at the shopping facility; and
offer a service to the user in response to a location of the user and a shopping history of the user.

15. The electronic device of claim 14, wherein the program module is further operable to determine the location of the user in response to electronic communication between the transceiver and one or more external electronic beacon devices placed at various points inside the shopping facility.

16. The electronic device of claim 14, wherein the input/output interface comprises a visual display unit operable to display the map of the shopping facility.

17. The electronic device of claim 16, wherein the program module is operable to:
generate navigation instructions in response to the location of the user and merchandise the user wishes to buy; and
display the navigation instructions on the visual display unit.

18. The electronic device of claim 14, wherein the map of the shopping facility comprises locational information, pricing information, and availability information of merchandise of the shopping facility.

19. An apparatus comprising a non-transitory, tangible computer readable storage medium storing a computer program, wherein the computer program contains instructions that when executed, perform:
detecting an electronic scan of a product in a facility;
extracting a property of the product in response to the detecting;
constructing, using at least in part the extracted property of the product, an information map of the facility; and
offering a service based on the information map of the facility.

20. The apparatus of claim 19, wherein:
the facility comprises a store; and
the product comprises at least one of: a physical merchandise of the store and a tag associated with the physical merchandise.

21. The apparatus of claim 19, wherein the property of the product comprises at least one of: a location of the product, a price of the product, and an availability of the product.

22. The apparatus of claim 19, wherein the instructions for the constructing the information map comprise instructions for constructing a personalized information map for each one of a plurality of customers based on a respective location and a respective shopping history for each customer.

23. The apparatus of claim 19, wherein the instructions for the offering the service comprise instructions for navigating a customer throughout the facility and advertising promotions on merchandise of the facility to the customer.

24. The apparatus of claim 19, wherein the instructions for the offering the service comprise instructions for gathering customer shopping statistics and recommending changes to the facility in response to the gathered customer shopping statistics.
